(19) United States
(12) Patent Application Publication
(10) Pub. No.: US 2026/0341720 A1
(43) Pub. Date: Oct. 29, 2026

(54) Method for Producing a Battery Paste and Battery

(71) Applicant: Bayerische Motoren Werke Aktiengesellschaft, Muenchen (DE)

(72) Inventor: Christoph NOWAK, Vaterstetten (DE)

(21) Appl. No.: 19/107,787

(22) PCT Filed: Aug. 30, 2023
(86) PCT No.: PCT/EP2023/073753

§ 371 Date: Feb. 28, 2025

(30) Foreign Application Priority Data
Sep. 1, 2022 (DE) 10 2022 122 199.7

(51) Int. Cl. H01M 4/62

(52) U.S. Cl. CPC H01M 4/625

(57) ABSTRACT

Processes for producing a battery paste, including electrically charging a particulate material to provide a charged particulate material, and dispersing the charged particulate material in a binder and a solvent to form the battery paste, are provided. Batteries including the battery paste obtained by the processes are further provided.

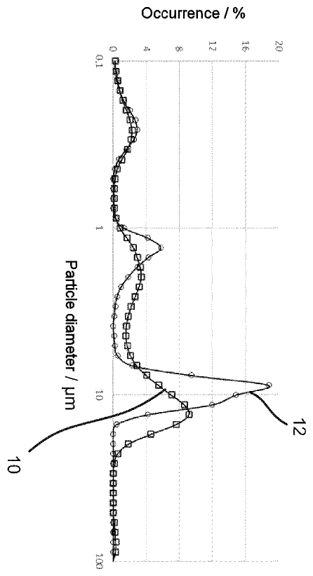

### BACKGROUND AND SUMMARY

The present disclosure relates to a process for producing a battery paste and to a battery comprising a battery paste produced by this process.

A battery comprises at least two different electrodes, a positive electrode (cathode) and a negative electrode (anode). Production of these electrodes employs a battery paste (also known as “slurry”) which comprises at least one active material and an electrode binder and a solvent, optionally together with additives such as electrical conductivity additives/conducting additives.

The term “battery” here and hereinbelow refers to both primary batteries and secondary batteries.

During production of the battery paste, one of the challenges is that of ensuring the most uniform possible distribution of the components involved. In order to achieve this in particular effort is made to very largely inhibit the agglomeration of particulate material present in the battery paste. Agglomeration has the result that primary particles of the particulate material combine to form larger secondary particles of the material, in other words, form agglomerates.

This effect may to a certain extent be countered through the use of apparatuses for mixing the components of the battery paste. However, the dispersing effect of such apparatuses is limited by their design, with the result that these apparatuses have a certain efficiency which cannot be improved further. It is also desirable to utilize the shortest possible dispersing processes to reduce production duration and costs. Furthermore, the energy input in the dispersing process cannot be increased arbitrarily since it is limited by the employed binder.

A further option for increasing the dispersing effect is that of adding dispersion additives which alter the surface properties of the components involved and ensure higher wettability, which in turn has an advantageous effect on dispersibility. The disadvantage of this solution is that the dispersion additives remain in the battery paste but in the later use of a battery with such a battery paste represent an inactive material, thus reducing the energy density of the respective battery. In addition, undesired side reactions with further components of the battery may occur, thus limiting the formulation freedom and/or reducing the reliability of the battery.

It is accordingly an object of the present disclosure to specify a process for producing a battery paste which allows improved dispersing of components of the battery paste. A further objective is to provide a more cost-effective and/or higher-performance battery.

### DETAILED DESCRIPTION

The object is achieved according to the present disclosure by a process for producing a battery paste, wherein in the process a particulate material is dispersed in a binder and a solvent to form the battery paste and wherein the particulate material is electrically charged prior to the dispersing.

The present disclosure is based on the basic concept of specifically influencing the surface tension of particulate materials that are to be employed in the battery paste in order thus to increase the wettability of the electrically charged particulate materials and thus achieve a good distribution of the components of the battery paste and counter agglomeration even without the use of dispersion additives or at least with a reduced amount of dispersion additives. It was identified that particulate materials typically employed in battery pastes are in many cases electrically conductive, thus making them particularly suitable for electrical charging.

The effect that the wettability of the particulate material is increased by electrical charging is attributed to the fact that the electrical charging increases the zeta potential of the particulate material in the mixture with the binder and the solvent. The solvate shell of the dispersed particulate material increases with increasing zeta potential to compensate the electrical charge thereof. At the same time the present dispersion is stabilized, since the charged particles repel one another, and the transmission of shear energy is improved.

The process according to the present disclosure thus makes it possible to achieve an improved dispersing effect without affecting the duration of the dispersing process or to shorten the duration of the dispersing process without affecting the dispersing effect.

The particulate material is preferably electrically charged using a discharge electrode.

The term “discharge electrode” in the present case describes an ionizer, for example an ionizer which generates charged particles and dispenses them onto the particulate material using a blower. Such discharge electrodes are available cheaply and are simple to use.

The discharge electrode is especially operated with a power in the range from 700 to 800 W per kg of material to be treated, for example with 750 W per kg of material to be treated.

In one variant the particulate material is charged for 3 to 8 minutes, especially for 4 to 5.5 minutes, for example for 5 minutes. In the case of charging for less than 3 minutes the electrical charging may be insufficiently pronounced, with the result that the wettability of the particulate material is not sufficiently increased, while in the case of charging for more than 8 minutes the cost, complexity and duration of electrical charging increases excessively.

To achieve a good distribution of the particulate material in the battery paste, the particulate material may have an average particle diameter d₅₀ of less than 7.0 μm after the dispersing in the battery paste.

The average particle diameter d₅₀ after the dispersing describes the particle sizes of secondary particles of the particulate material, in other words of agglomerates of primary particles of the particulate material such as are added to the dispersing process.

The average particle diameter d₅₀ may be determined by static light scattering in a particle size analyzer.

It is preferable when the particulate material is a conducting additive. Conducting additives are electrically conductive as a consequence of their function and are therefore particularly suitable for electrical charging. Conducting additives are also already provided in customary formulations of battery pastes, so that the formulations need not be altered.

It is preferable when the conducting additive is carbon black. It is known that while carbon black is commercially available as a primary particle having an average particle diameter d₅₀ in the nanometer range, it can agglomerate into secondary particles having an average particle diameter d₅₀ of about 10 μm during the dispersing process. The electrical charging according to the invention makes it possible to counter this effect in a simple and reliable fashion.

To further optimize the wettability of the particulate material, the weight ratio of conducting additive to solvent may be in the range from 1:1 to 1:4, especially in the range from 1:3 to 1:4, for example 1:3.5.

In one variant the solvent is water or contains water. Water is a particularly polar solvent and electrostatic charging of the particulate material can therefore have a particularly marked effect on the wettability.

Water-based battery pastes are especially suitable for anode battery pastes.

In one embodiment the dispersing is performed in a nitrogen atmosphere. This is especially advantageous if at least one of the components employed in the battery paste is flammable and/or highly flammable, for example in the case that a flammable solvent is used.

To prevent the electrical charging of the particulate material from being neutralized again, the dispersing may be performed in a mixing vessel which is protected against electrical discharging. Such mixing vessels are typically earthed to inhibit unwanted electrical charging during the dispersing process. It has now been identified, by contrast, that the specific electrical charging and the maintenance of this electrical charging can have an advantageous effect on the dispersing process.

The object of the present disclosure is further achieved by a battery comprising a battery paste obtained by the above-described process.

The advantages and features of the process according to the present disclosure accordingly apply to the battery according to the present disclosure and vice versa and the foregoing is incorporated by reference.

The battery is preferably a secondary battery, in particular a lithium-ion accumulator.

Further features and properties of the present disclosure are derivable from the examples which follow, which are not to be understood in a limiting sense, and from the drawing. This shows a particle size distribution diagram.

### Laboratory Experiment for Production of a Battery Paste

### Example 1: Comparative Example

A mixing vessel (mixer from Thinky) was initially charged with 0.81 g of binder (water-soluble binder), 7.1 g of water as solvent and 0.23 g of carbon black as particulate material and conducting additive.

The total weight of the mixture was thus 8 g and the total ratio of conducting additive to binder was 1:3.5.

The mixture was mixed in the mixing vessel at 2000 rpm for 30 minutes to afford a battery paste.

### Example 2

Example 2 was performed analogously to example 1 with the exception that the employed carbon black was pretreated before addition to the mixture.

To this end the carbon black was treated with an ionizer from KERN (YBI-01) for 5 minutes at a power of the ionizer of 6 W and thus electrically charged.

### Measurement of Particle Size Distribution

The particle size distribution of the dispersions/battery pastes obtained according to examples 1 and 2 was measured by static light scattering according to the following protocol.

40 g of solvent (DM water) and then 0.5 g of the dispersion/battery paste to be characterized were weighed into a suitable vessel. The dispersion was homogenized by stirring and, if required, by addition of a suspension promoter (for example methoxypropyl acetate).

The particle size of the homogenized dispersion was determined by static light scattering using a HORIBA LA-950V2 particle analyzer (Retsch technology).

The dispersion measured in each case was tested for sedimentation after measurement to ensure that no sedimentation had occurred during measurement.

The integrity of the measurements was ensured by performing them in triplicate.

The sole figure shows the measured results for examples 1 and 2, wherein curve 10 describes (noninventive) example 1 and curve 12 describes inventive example 2.

As is apparent, the use of the electrically charged conducting additive shifts the particle size distribution toward smaller particle sizes.

The average particle diameter d₅₀ in (noninventive) example 1 was 7.7 μm and in example 2 was 6.73 μm. A decrease in the average particle diameter d₅₀ as a result of the electrical charging of the carbon black is therefore observable.

In addition, the distribution in example 2 more closely approximates a trimodal distribution than is the case for example 1. The process according to the present disclosure thus ensures not only the desired reduction in the average particle diameter d₅₀ but also a defined distribution of the particle diameters.

1-10. (canceled)

11. A process for producing a battery paste, comprising:
electrically charging a particulate material to provide a charged particulate material; and
dispersing the charged particulate material in a binder and a solvent to form the battery paste.

12. The process according to claim 11, wherein the particulate material is electrically charged using a discharge electrode.

13. The process according to claim 12, wherein the discharge electrode is operated at a power of from 700 to 800 W per kg of the particulate material.

14. The process according to claim 11, wherein the particulate material is charged for 3 to 8 minutes.

15. The process according to claim 11, wherein the particulate material is charged for 4 to 5.5 minutes.

16. The process according to claim 11, wherein the particulate material has an average particle diameter d₅₀ of less than 7.0 μm after the dispersing.

17. The process according to claim 11, wherein the particulate material is a conducting additive.

18. The process according to claim 17, wherein the conducting additive is carbon black.

19. The process according to claim 17, wherein the weight ratio of the conducting additive to the solvent is from 1:1 to 1:4.

20. The process according to claim 17, wherein the weight ratio of the conducting additive to the solvent is from 1:3 to 1:4.

21. The process according to claim 11, wherein the solvent is or contains water.

22. The process according to claim 11, wherein the dispersing is performed in a nitrogen atmosphere.

23. The process according to claim 11, wherein the dispersing is performed in a mixing vessel protected against electrical discharging.

24. A battery comprising a battery paste obtained by the process according to claim 11.
